(19) United States
(12) Patent Application Publication
(10) Pub. No.: US 2016/0097750 A1
(43) Pub. Date: Apr. 7, 2016

(54) Magnetic Nanoparticles and Integration Platform

(71) Applicant: Chevron U.S.A. Inc., San Ramon, CA (US)

(72) Inventors: Brian Van Herzen, Carson City, NV (US); Steven Van Fleet, Lagrangeville, NY (US); Rushan R. Sakhibgareev, Spring, TX (US)

(21) Appl. No.: 14/868,523

(22) Filed: Sep. 29, 2015

Related U.S. Application Data
(60) Provisional application No. 62/059,577, filed on Oct. 3, 2014.

(51) Int. Cl. G01N 31/22; E21B 47/10; C23C 28/04

(52) U.S. Cl. CPC G01N 31/22; C23C 28/04; E21B 47/1015

(57) ABSTRACT

The present application provides magnetic nanoparticles, methods of preparing magnetic nanoparticles, and applications employing magnetic nanoparticles. In embodiments, the magnetic nanoparticles contain one or more conformal coatings, including a coating that contains a fluorescent materials, such as upconverting fluorescent materials. In enhanced oil recovery applications, colloidal solution contain nanoparticles having one or more conformal coatings is prepared for use to monitor the productivity of hydrocarbons and water from the reservoir formation penetrated by a well.

### CROSS-REFERENCE TO RELATED APPLICATIONS

This application claims benefit under 35 USC 119 of U.S. Provisional Patent Application No. 62/059,577 with a filing date of Oct. 3, 2014. This application claims priority to and benefits from the foregoing, the disclosure of which is incorporated herein by reference.

### FIELD OF THE INVENTION

The present application relates to magnetic nanoparticles, methods of preparing magnetic nanoparticles, and applications thereof.

### BACKGROUND OF THE INVENTION

Secondary recovery is accomplished through the injection of water and chemicals at injection wells into the reservoir to mobilize and sweep hydrocarbons to production wells. The recovery process depends on continuity and uniformity in terms of fluid transmissibility and oil saturation between injection and production wells. There is an increased interest in tertiary or enhanced oil recovery pilots and projects that operators put in their plans. It requires accurate reservoir characterization and surveillance to calibrate dynamic models and understand the flow through the target reservoir.

During inter-well tracer studies, injection water is typically tagged with tracer material that is injected into injection well, and then the tracer concentration is monitored at production wells as a function of time. There are interpretation methods available that allows calculating swept volume, sweep efficiency, flow geometry and other parameters. In the prior art, there is a need for the sampling, shipment and the laboratory analysis to measure the tracer concentration.

Tracer particles are often use in fluids to provide information on the flow of fluid and can be used to determine hydrogeologic and other parameters, particularly hydraulic conductivity. Tracer particles can be deployed in and from boreholes of wells, for use in locating fractures and determining fluid exchange between different regions. Examples of tracer particles include magnetic nanoparticles with fluorescent layers which can be used in very small concentration.

The preparation of magnetic nanoparticles, including those with fluorescent layers, presents a number of challenges. For example, magnets attract each other in high concentrations during coating of layers on the particles, resulting in non-uniform coatings and reduced performance. Further, because the magnetization remains in force, ultrasonication is required to separate the particles, which can disrupt or attenuate the layer formation process. There is a need therefore for processes for preparing magnetic nanoparticles that reduce or eliminate these challenges.

In addition, groundwater tracing has been important over the past decades to determine groundwater flows, pollution monitoring, and in water injection for hydrocarbon recovery. Traditionally, radioactive tracers have been used. However, use of such tracers has been made illegal in most countries. There is a need for non-radioactive tracers that can be detected in the part per billion concentration level for these and other applications.

### SUMMARY

The present application provides compositions and methods that meet the needs identified above.

In embodiments, methods of preparing a magnetic nanoparticle are provided. Suitably, such methods comprise providing a nanoparticle core comprising a ferromagnetic material, heating the nanoparticle core to a temperature above a Curie temperature of the ferromagnetic material, maintaining the temperature of the nanoparticle core above the Curie temperature of the ferromagnetic material, and while maintaining the temperature, depositing a conformal separation layer on the nanoparticle core, depositing a conformal intermediate layer on the conformal separation layer, depositing a conformal capping layer on the conformal intermediate layer to form the magnetic nanoparticle, and lowering the temperature of the magnetic nanoparticle below the Curie temperature of the ferromagnetic material.

In exemplary embodiments, the ferromagnetic material comprises nickel, cobalt, iron or oxides thereof. Suitably, heating the nanoparticle core comprises heating to a temperature that is about 5 degrees to about 500 degrees above the Curie temperature of the ferromagnetic material, and maintaining the temperature comprises maintaining at a temperature that is about 5 degrees to about 500 degrees above the Curie temperature of the ferromagnetic material.

In embodiments, depositing the conformal separation layer comprises depositing a silica layer or silicon dioxide layer. Suitably, depositing the conformal intermediate layer comprises depositing a fluorescent layer, including a fluorescent upconverting layer. In embodiments, depositing the conformal capping layer comprises depositing a silica layer or silicon dioxide layer. Suitably, the methods further comprise depositing a conformal outer coating on the conformal capping layer, for example, depositing a hydrophilic coating layer.

In embodiments, the lowering the temperature of the magnetic particle below the Curie temperature of the ferromagnetic material suitably occurs at a rate of about 5 degrees per minute or less.

Provided herein are magnetic nanoparticles prepared by the various methods described throughout.

Also provided are magnetic fluorescent nanoparticles comprising a core comprising a ferromagnetic material, a conformal separation layer on the ferromagnetic core, a conformal fluorescent layer on the conformal separation layer, and a conformal capping layer on the conformal fluorescent layer.

In further embodiments, methods of tracing a magnetic fluorescent nanoparticle in a fluid are provided. Such methods suitably comprise providing the magnetic fluorescent nanoparticle comprising a core comprising a ferromagnetic material, a conformal separation layer on the ferromagnetic core, a conformal fluorescent layer on the conformal separation layer, and a conformal capping layer on the conformal fluorescent layer, introducing the magnetic fluorescent nanoparticle into the fluid, and measuring one or more characteristics of the magnetic fluorescent nanoparticle in the fluid.

Also provided are devices for detecting magnetic fluorescent nanoparticles in a liquid. Suitably, the devices comprise a flow cell, a magnet positioned near the flow cell such that a magnetic field of the magnet can act upon the liquid, a light source which emits in the absorption band of a fluorophore of the magnetic fluorescent nanoparticles, and a spectrometer.

In embodiments, the light source passes through a dichroic mirror and then through a focusing lens before illuminating the magnetic fluorescent nanoparticles.

Also provided are methods for detecting magnetic fluorescent nanoparticles in a liquid. The methods suitably comprise passing the liquid near a magnet to accumulate the magnetic fluorescent nanoparticles, illuminating the magnetic fluorescent nanoparticles with a light source to excite the fluorescence of the magnetic fluorescent nanoparticles and detecting the fluorescence.

Further embodiments, features, and advantages of the embodiments, as well as the structure and operation of the various embodiments, are described in detail below with reference to accompanying drawings.

### BRIEF DESCRIPTION OF THE FIGURES

FIG. 1 shows a magnetic nanoparticle prepared in accordance with embodiments described herein.

FIG. 2 shows a magnetic fluorescent nanoparticle prepared in accordance with embodiments described herein.

### DETAILED DESCRIPTION

It should be appreciated that the particular implementations shown and described herein are examples and are not intended to otherwise limit the scope of the application in any way.

The published patents, patent applications, websites, company names, and scientific literature referred to herein are hereby incorporated by reference in their entireties to the same extent as if each was specifically and individually indicated to be incorporated by reference. Any conflict between any reference cited herein and the specific teachings of this specification shall be resolved in favor of the latter. Likewise, any conflict between an art-understood definition of a word or phrase and a definition of the word or phrase as specifically taught in this specification shall be resolved in favor of the latter.

As used in this specification, the singular forms “a,” “an” and “the” specifically also encompass the plural forms of the terms to which they refer, unless the content clearly dictates otherwise. The term “about” is used herein to mean approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 20%.

Technical and scientific terms used herein have the meaning commonly understood by one of skill in the art to which the present application pertains, unless otherwise defined. Reference is made herein to various methodologies and materials known to those of ordinary skill in the art.

Methods of Preparing Magnetic Nanoparticles and Nanoparticles Prepared Thereby

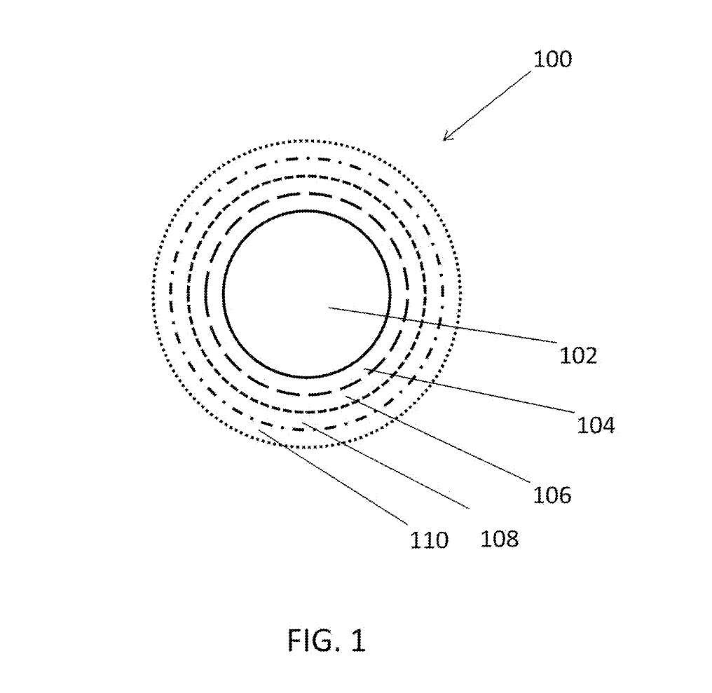

In embodiments, provided herein are methods of preparing magnetic nanoparticles (e.g., magnetic nanoparticle 100 of FIG. 1).

As used herein, the term “magnetic” means that a nanoparticle as described herein produces a magnetic field and attracts other magnetic materials.

As used herein, the term “nanoparticle” refers to a structure having at least one region or characteristic dimension with a dimension of less than about 500 nm, and down to on the order of about 1 nm. Nanoparticles can have any suitable shape, e.g., a rectangle, a circle, a sphere, a cube, an ellipse, or other regular or irregular shapes.

As used herein, “FMNP” refers to fluorescent magnetic nanoparticles.

As used herein, the terms “rare earth upconverting phosphor (RUP) materials”, or “upconverting material”, or “upconverter” refer to upconverting phosphor materials containing rare earth or lanthanides. In one embodiment, the upconverting phosphor composition includes a host, one or more absorbers, and one or more emitters.

As used herein, “thermolysis” refers to the thermal decomposition of molecular or polymeric precursors into a solid state material (e.g., yttrium nitrate thermolyzing to yttrium oxide plus nitrogen oxides).

Suitably, nanoparticles have all characteristic dimensions less than about 500 nm, and in embodiments, nanoparticles as provided herein are spherical, or substantially spherical (i.e., of a general spherical shape), having all characteristic dimensions less than about 500 nm, more suitably all characteristics dimensions are less than about 400 nm, less than about 300 nm, less than about 200 nm, less than about 100 nm, less than about 50 nm, less than about 20 nm, less than about 10 nm, or all characteristic dimensions are about 10 nm to about 500 nm, about 10 nm to about 400 nm, about 10 nm to about 300 nm, about 10 nm to about 200 nm, about 10 nm to about 100 nm, about 10 nm to about 90 nm, about 20 nm to about 80 nm, about 30 nm to about 70 nm, or about 10 nm, about 20 nm, about 30 nm, about 40 nm, about 50 nm, about 60 nm, about 70 nm, about 80 nm, about 90 nm, about 100 nm, about 110 nm, about 120 nm, about 130 nm, about 140 nm, about 150 nm, about 160 nm, about 170 nm, about 180 nm, about 190 nm, or about 200 nm.

The methods suitably comprise providing a nanoparticle core (102 in FIG. 1). Suitable materials for use as nanoparticle core 102 are ferromagnetic materials. As used herein, “ferromagnetic material” refers to a material that exhibits a long-range ordering phenomenon at the atomic level which causes unpaired electron spins to line up parallel with each other in a “domain.”

Exemplary ferromagnetic materials for use in the methods and nanoparticles described herein include the materials shown in the table below. Also provided is the Curie temperature (K) for the each of the materials. As used herein, Curie temperature refers to the temperature above which the ferromagnetic properties of a material, i.e., the ability of electron spins to line-up, is lost.

| | Curie |
|---|---|
| Material | temperature (K.) |
| Co | 1388 |
| Fe | 1043 |
| Fe₂O₃ | 948 |
| FeOFe₂O₃ | 858 |
| NiOFe₂O₃ | 858 |
| CuOFe₂O₃ | 728 |
| MgOFe₂O₃ | 713 |
| MnBi | 630 |
| Ni | 627 |
| MnSb | 587 |
| MnOFe₂O₃ | 573 |
| Y3Fe₅O₁₂ | 560 |
| CrO₂ | 386 |
| MnAs | 318 |
| Gd | 292 |
| Dy | 88 |
| EuO | 69 |

Suitably, the material for use in the nanoparticle core comprises nickel (Ni), cobalt (Co), Iron (Fe) or oxides thereof. In embodiments, the material of the nanoparticle core is a substantially pure material comprising only the ferromagnetic material. In other embodiments, additional materials can be present in the core, including for example, fluorescent materials. However, suitably, additional fluorescent materials are absent from the nanoparticle core such that no fluorescent material is included in the core.

In embodiments of the methods described herein, the nanoparticle core 102 is heated to a temperature above the Curie temperature of the ferromagnetic material (also called the Curie temperature of the nanoparticle core for simplicity throughout). Methods of heating the nanoparticle include various forms of water or oil baths, use of heated air or other materials which can transfer heat to the nanoparticle core.

As described throughout, suitably the nanoparticle core is heated to a temperature that is at least about 5 degrees above the Curie temperature, more suitably at least about 10 degrees above the Curie temperature, at least about 50 degrees, at least about 100 degrees, at least about 200 degrees, at least about 300 degrees, at least about 400 degrees, at least about 500 degrees, at least about 600 degrees, at least about 700 degrees, at least about 800 degrees, at least about 900 degrees, or at least about 1000 degrees above the Curie temperature. In other embodiments, the nanoparticle core is heated to a temperature that is about 5 degrees to about 1000 degrees above the Curie temperature, for example about 100 degrees to about 1000 degrees, about 200 degrees to about 1000 degrees, about 300 degrees to about 1000 degrees, about 400 degrees to about 1000 degrees or about 500 degrees to about 1000 degrees above the Curie temperature of the nanoparticle core, i.e., the Curie temperature of the material of the nanoparticle core.

The methods further comprise maintaining the temperature of the nanoparticle core above the Curie temperature of the ferromagnetic material. As used herein “maintaining the temperature” means that the temperature of the nanoparticle core is kept within a variation of about 5-20% for a determined amount of time (suitably the time required for deposition of various layers). Suitably, the nanoparticle core is maintained at a temperature that is at least about 5 degrees above the Curie temperature, more suitably at least about 10 degrees above the Curie temperature, at least about 50 degrees, at least about 100 degrees, at least about 200 degrees, at least about 300 degrees, at least about 400 degrees, at least about 500 degrees, at least about 600 degrees, at least about 700 degrees, at least about 800 degrees, at least about 900 degrees, or at least about 1000 degrees above the Curie temperature. In other embodiments, the nanoparticle core is maintained at a temperature that is about 5 degrees to about 1000 degrees above the Curie temperature, for example about 100 degrees to about 1000 degrees, about 200 degrees to about 1000 degrees, about 300 degrees to about 1000 degrees, about 400 degrees to about 1000 degrees or about 500 degrees to about 1000 degrees above the Curie temperature of the nanoparticle core.

The methods further comprise conducting various layer depositions on the nanoparticle core while the temperature of the nanoparticle core is maintained at a temperature above the Curie temperature of the material of the nanoparticle core. Thus, depositing of additional materials on the nanoparticle core occurs while the temperature of the nanoparticle core is above the Curie temperature. Maintaining the temperature of the nanoparticle core suitably lasts until the final, desired layer is deposited.

In embodiments, while maintaining the temperature of the nanoparticle core above the Curie temperature of the material of the core, a conformal separation layer 104 is deposited on the nanoparticle core 102 of FIG. 1.

As used herein, the term “conformal” means a completely formed layer or coating which contains no substantial cracks, pits or other defects in the layer, and suitably exhibits little if any variation in thickness throughout the layer. As used herein, conformal layers that are formed on a nanoparticle core and/or on other layers completely cover an underlying core or layer, i.e. form a spherically encapsulating layer on an underlying nanoparticle core and/or other underlying layer(s).

As used herein “separation layer” means a material layer that provides separation between the nanoparticle core and a further layer on top of (i.e., added to) the separation layer. Suitably, separation layer comprises a silica layer or silicon dioxide layer, or materials comprising silica or silicon dioxide. Separation layer serves to separate the ferromagnetic material of the core of the nanoparticle from an outer layer, suitably an outer fluorescent layer, and thereby reduce quenching of the fluorescent layer.

As used herein “deposited” means the addition of or more materials on a substrate, including a nanoparticle core or further layer. Methods of deposition that can be used herein are known in the art and include for example, thin-film deposition methods, such as plating, chemical vapor deposition or atomic layer deposition, as well as various solution or fluidized bed gas reactions, etc.

As shown in FIG. 1, the methods further comprise depositing a conformal intermediate layer 106 on the conformal separation layer 104. As used herein, an “intermediate layer” refers to a layer that covers or lies on the separation layer 104, and is suitably covered by a capping layer 110. However, the use of a capping layer 110, as described herein, is optional and can be eliminated. In exemplary embodiments, intermediate layer 106 comprises a fluorescent material, such that the intermediate layer is a fluorescent layer. Suitably, the fluorescent material is a fluorescent upconverting material, such that the fluorescent layer is a fluorescent upconverting layer.

Exemplary fluorescent materials that can be utilized in embodiments described herein include, for example, a fluorescent dye, a fluorescent organo-metallic compound, an up-converting fluorescent phosphor, a down-converting fluorescent phosphor, and a fluorescent quantum dot. Exemplary up-converting fluorescent materials (i.e., materials that absorb light in the near infrared (NIR) and emit light in the visible range) include a phosphor fluoride, such as a phosphor fluoride having a formula of YF₃:Yb,Er or NaYF₄:Yb,Er. In some embodiments, the up-converting phosphor contains molybdenum. Exemplary down-converting phosphors suitably have a formula of CaS:Eu³⁺ or SiAlO₂:Eu³⁺. Exemplary fluorescent quantum dots that can be utilized include CdSe/CdS, ZnS/CdSe, or GaAs.

In one embodiment, the invention provides an optical encoding method characterized as being accurate with a depth of multiplexing and speed. The method involves the use of more than one upconverting lanthanide material, preferably the use of more than one Rare earth Upconverting Phosphor material. Optionally, the upconverting materials may be combined with fluorescent dyes or quantum dots to increase the number of available tracers. The host materials may include, without limitation, sodium yttrium fluoride (NaYF4), lanthanum fluoride (LaF3), lanthanum oxysulfide, yttrium oxysulfide, yttrium fluoride (YF3), yttrium gallate, yttrium aluminum garnet, gadolinium fluoride (GdF3), barium yttrium fluoride (BaYF3, BaY2F5), and gadolinium oxysulfide. Absorber/emitter combination examples include ytterbium/erbium, ytterbium/thulium, and ytterbium/holmium, erbium/thulium, although others may also be used.

In one embodiment, the absorber is preferably ytterbium, erbium or samarium and the emitting centers are preferably erbium, holmium, terbium, thulium, praseodymium, neodymium or didymium. In one embodiment, the molar ratio of absorber: emitting center is at least 1:1, with ratios of at least 3:1 to 5:1 being more common. Preferably, the ratio is at least 8:1 to 10:1, more preferably at least 11:1 to 20:1. The ratio typically is less than 250:1, preferably less than 100:1, and more preferably less than 50:1 to 25:1.

The optimum ratio of absorber (e.g., ytterbium) to emitting center (e.g., erbium, thulium, or holmium) varies, depending upon the specific absorber/emitter couple. For example, the absorber: emitter ratio for Yb:Er couples is typically in the range of about 20:1 to about 100:1, whereas the absorber:emitter ratio for Yb:Tm and Yb:Ho couples is typically in the range of about 500:1 to about 2000:1. For most applications, up-converting phosphors may conveniently comprise about 10-30% Yb and either: about 1-8% Er, about 0.5-0.001% Ho, or about 0.5-0.001% Tm and 0.5-001 for Pr.

Exemplary formulae for upconverting phosphor materials include, without limitation, the following: Na(YxYbyErz)F4, where x is 0.7 to 0.9, y is 0.09 to 0.29, and z is 0.05 to 0.01; Na(YxYbyHoz)F4, where x is 0.7 to 0.9, y is 0.0995 to 0.2995, and z is 0.0005 to 0.001; Na(YxYbyTmz)F4, where x is 0.7 to 0.9, y is 0.0995 to 0.2995, and z is 0.0005 to 0.001; and, (YxYbyErz)O2S, where x is 0.7 to 0.9, y is 0.05 to 0.12; and z is 0.05 to 0.12.

In one embodiment, the formulae for upconverting phosphor materials include, without limitation, the following: [(Y0.8Yb0.19(RE)0.01)2O2X, X═O or S], with RE=Tm, Er, Ho, Pr, Nd and Dy. Elements Tm, Er, Ho, Pr, Nd and Dy act as the emitters, and Yb acts as a sensitizer for 980 nm excitation; and, Na(YxYby(RE)z)F4 with RE=Tm, Er, Ho, Pr, Nd and Dy. Elements Tm, Er, Ho, Pr, Nd and Dy act as the emitters, and Yb acts as a sensitizer for the 980 nm excitation.

In one embodiment, the dyes that can be optionally included with the upconverting materials include fluorescent organic dye molecules. Examples of such dyes include, without limitation, the following: rhodamines, cyanines, xanthenes, acridines, oxazines, porphyrins, and phthalocyanines Quantum dots are tiny nanocrystals composed of periodic groups of II-VI, III-V, or IV-VI materials that range in size from 2-10 nanometers or roughly the size of 10 to 50 atoms in diameter. Typically, quantum dot cores are composed of cadmium sulfide (CdS), cadmium selenide (CdSe), or cadmium telluride (CdTe). The semiconductor material used for a particular size core is chosen based upon the emission wavelength range being targeted: CdS for UV-blue, CdSe for the bulk of the visible spectrum, CdTe for the far red and near-infrared. These cores can be synthesized as nano-sized (10 meters) spheres, rods, pyramids, boomerangs, tetrapods, or many other shapes. Typically, spherical particles or slightly elongated ellipsoidal (rod-like) materials are used.

In embodiments as illustrated in FIG. 1, a conformal capping layer 108 is deposited on the conformal intermediate layer 106, so as to form the magnetic nanoparticle. As used herein a “capping layer” refers to a coating or layer that covers or layers over the intermediate layer 106, suitably protecting the intermediate layer from outside environmental factors. In embodiments, the capping layer 108 comprises a silica layer or silicon dioxide layer, or materials comprising silica or silicon dioxide.

The methods provided herein further comprise lowering the temperature of the magnetic particle below the Curie temperature of the ferromagnetic material, following the completion of the final, desired layer. Suitably, lowering of the temperature after the final layer has been deposited on the magnetic nanoparticle (e.g., the capping layer in some embodiments) occurs at a rate that is slow enough so that a single domain or a few domains are established in the nanoparticle core. Suitably, the rate of lowering the temperature below the Curie temperature occurs at rate of about 50 degrees per minute or less, or about 40 degrees per minute or less, about 30 degrees per minute or less, about 20 degrees per minute or less, about 10 degrees per minute or less, about 9 degrees per minute or less, about 8 degrees per minute or less, about 7 degrees per minute or less, about 6 degrees per minute or less, about 5 degrees per minute or less, about 4 degrees per minute or less, about 3 degrees per minute or less, about 2 degrees per minute or less, about 1 degrees per minute or less, about 0.5 degrees per minute or less, or about 0.1 degrees per minute or less.

In further embodiments, an outer coating 110, suitably a conformal outer coating, is deposited on the capping layer 108. As described herein, an “outer coating” refers to the final coating on a magnetic nanoparticle that covers a capping layer. In embodiments, an outer coating 110 is deposited while the temperature of the nanoparticle core is maintained above the Curie temperature of the nanoparticle core material. However, in additional embodiments, the outer coating can be deposited while the temperature of the nanoparticle core is below the Curie temperature of the nanoparticle core material.

In some embodiments, the outer coating 110 comprises a hydrophilic coating layer. In embodiments, the outer coating layer can comprise a functional group. Exemplary functional group includes —COOH, —CHO, —NH₂, —SH, —S—S—, an epoxy group, and a trimethoxysilyl group.

Additional layers can also be deposited between or in addition to those layers described herein in further embodiments.

Also provided herein are magnetic nanoparticles prepared by the various methods described herein.

By utilizing the methods described herein, the necessity to sonicate (i.e., ultrasonicate) nanoparticles following or during coating to separate the nanoparticles can be largely eliminated, reducing the chance of producing nanoparticles that contain incomplete or sub-optimal coatings due to disruption from sonication.

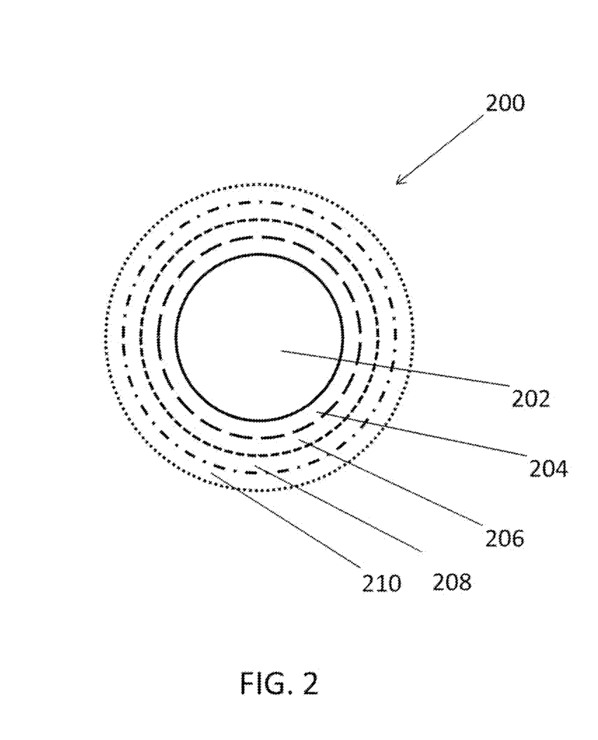

In embodiments, magnetic fluorescent nanoparticles 200, as shown in FIG. 2, are provided. Suitably, such magnetic fluorescent nanoparticles comprise a core 202 comprising a ferromagnetic material, a conformal separation layer 204 on the ferromagnetic core, a conformal fluorescent layer 206 on the conformal separation layer, and a conformal capping layer 208 on the conformal fluorescent layer.

As described herein, the various conformal layers of the magnetic fluorescent nanoparticles are characterized by a completely formed layer or coating which contains no substantial cracks, pits or other defects in the layer, and suitably exhibits little if any variation in thickness throughout the layer.

Exemplary ferromagnetic materials that can be used in the magnetic fluorescent nanoparticles are described herein, and suitably include nickel, cobalt, iron, or oxides thereof.

Suitably, conformal separation layer comprises silica or silicon dioxide, and the conformal capping layer comprises silica or silicon dioxide.

In embodiments, the conformal fluorescent layer comprises an upconverting fluorescent material, examples of which are described herein or otherwise known in the art.

In embodiments, the magnetic fluorescent nanoparticles described herein further comprise a conformal outer coating 210 on the capping layer. In exemplary embodiments, the conformal coating can comprise a hydrophobic coating material.

In further embodiments, provided herein are methods of tracing a magnetic fluorescent nanoparticle in a fluid. Such methods suitably comprise providing a magnetic fluorescent nanoparticle as described herein. Suitably, the magnetic fluorescent nanoparticle comprises a core comprising a ferromagnetic material, a conformal separation layer on the ferromagnetic core, a conformal fluorescent layer on the conformal separation layer, and a conformal capping layer on the conformal fluorescent layer. The methods further comprise introducing the magnetic fluorescent nanoparticle into the fluid and measuring one or more characteristics of the magnetic fluorescent nanoparticle in the fluid.

Measuring one or more characteristics of the magnetic fluorescent nanoparticles suitably comprise measuring fluid velocity, turbidity, location, etc. of the nanoparticles, and thereby the fluid in which they are dispersed or added. Instrumentation and methodology for performing such measurements are well known in the art. The methods described herein are readily applied to applications such as groundwater tracing, oil well characterization, enhanced oil recovery, fracking characterization, etc.

In one embodiment, the ferromagnetic nanoparticles comprising carbon coated metallic cobalt has an average diameter of about 60 nm. In one embodiment, the conductive nanoparticle comprises a silica insulating coating layer with a thickness of approximately 10-15 nm. Generation of the insulating layer over the conductive nanoparticle in one embodiment utilizes a combination of gradual addition and continuous sonication and pulsed high power sonication with magnetic particle concentration that doesn't exceed 0.1 mg/ml.

In one embodiment, the UCP particle is formed according to a protocol where silica-coated magnetic particles are dispersed in an acetone solution containing the dissolved trifluoroacetate salts of yttrium/ytterbium/thulium in a mole ratio of 0.90:0.099:0.001. The mixture is sonicated with high power probe for 5 minutes with 2 seconds on and 2 seconds off sequence to prevent excessive heating of the suspension. The suspension is stirred to keep the magnetic particles moving throughout the solvent removal process. The coating thickness of UCP material can be controlled by varying the weight ratio of the UCP precursor (trifluoroacetate salts) to the silica coated magnetic beads. The annealing temperature was kept at 775° C. with argon cover gas in platinum crucible to ensure rapid heating to quickly pass through residual water decomposition at 300° C. In one embodiment, the thickness of UCP material can be around 30 nm.

On top of the UCP material, a silane coating is formed to build different functionalities in order to make the particle stable in reservoir conditions. It can be group of chemicals related to charged or neutral hydrophilic groups that can be alcohols, carboxylic acid, amine, amide, ester, ether oxide, sulphonate, phosphonate, carboxylates, fluoro benzoic acids, poly-vinylalcohol, methylated carbon, sugars, polyols, polyethylene glycol, gluconamide or succinic acid. For example, the list can include 3-6-difluoroBenzoic Acid, Di-2,4-Amino-Fluoro Benzoate, 2-Amino-4-Fluorobezoic Carboxylate, Di-2,5-Amino-Fluoro Benzoate, 2-Amino-5-Fluorobenzoic Carboxylate, Formyltriphenylphosphonium Carboxylate.

Applications of NanoParticles: The nanoparticles can be used in improved/enhanced oil recovery applications. Fluids containing FMNP tracer in the fracture are used to monitor and quantify the amount and source of water and hydrocarbons produced from the formation. In one embodiment, a fluid containing tracer carrier that has controlled release FMNP tracer is pumped into the formation during hydraulic fracturing. The tracer is slowly released from the composite into the fluid produced from the formation.

In one embodiment, the tracer carrier is a composite with multiple FMNP tracers. This composite can be oil-insoluble or water-insoluble adsorbent that is porous particulate comprising ceramic, organic polymer, alumino-silicate, silicon carbide, alumina or silica based material, metal oxide, calcined metal oxide, and mixtures thereof. Tracer carrier can be the composite that is the adsorbent in the form of the porous proppant or sand that can withstand in-situ stress.

As produced fluid passes through or circulates around the tracer carrier the tracer slowly dissolves over constant rate over extended period of time into the water or hydrocarbon phase. The tracer carrier is characterized by time release capability which permits continuous supply of the tracer into the target zone. Slow release of the tracers can provide the surveillance period up to 5 years and beyond. When there are number of stimulated zones in the wellbore a different hydrocarbon and water tracers can be introduced in different zones. The term zone may refer to separate formations within the wellbore or separate areas within single formation within the wellbore.

In one embodiment, one may utilize tracer carriers releasing tracer material by diffusion in wells and thus meeting the requirements of having tracer release that have constant release rates over long period of time. The tracer materials are exposed to the well fluids either from the outside of the completion or inside depending on the tracer carrier system. When they come in contact with hydrocarbons or water the tracer can be released from the matrix or composite at relatively constant rate. When FMNP tracer arrives downstream at surface, it can be analyzed onsite with the hand held or in-line automatic detector.

### EXAMPLES

The following illustrative examples are intended to be non-limiting.

### Example 1

Preparation of colloidal solution of surface modified fluorescent magnetic nanoparticle coated with carboxylic acid as a precursor. To synthesize amino propyl silane precursor coating a following reagents needed: upconverting phosphor removed during the settling process, anhydrous isopropanol, amino propyl triethoxy silane (APTES), 7N NH₃ in methanol, anhydrous methanol. The synthesis procedure is as follows: a) Suspend 0.5 gram of upconverting phosphor in 250 ml isopropanol and sonicate in bath at 40° C. with high powered pulses (2 sec on, 2 sec off) to disperse it for 5 minutes. b) Add 200 ul of APTES and continue with pulsed high power sonication for several minutes. c) Add 5 ml of 7N NH₃ in methanol. d) Add 600 ul of water, continue high power sonication for 1 hour. Collect and wash the samples for FTIR analysis. The C—H stretch at 2800-3000 cm⁻¹ and Si—O stretch at 1080 cm⁻¹ should confirm that the surface was modified. If not steps c and d can be repeated. e) After the sonication let settle for 2 minutes to remove any large agglomerates. f) Decant suspended nanoparticles and spin down. g) Wash 1 time with isopropanol and 2 times with methanol. H) Dry in vacuum at 60° C. overnight.

### Example 2

Preparation of colloidal solution of surface modified fluorescent magnetic nanoparticle coated with silane succinic anhydrate (SSA) as a precursor. To synthesize silane succinic anhydrate precursor coating a following reagents needed: upconverting phosphor of 150 nm size removed during the settling process, ultra dry tetrahydrofuran (THF), 3-triethoxysilyl propyl-succinic anhydrate (SSA), anhydrous methanol. The reagent is not hydrolytically stable and will slowly hydrolyze from moisture in the atmosphere if it is stored over 1 week. The synthesis procedure is as follows: a) Suspend, cap and purge with dry nitrogen 0.5 gram of upconverting phosphor in 250 ml ultra dry THF and sonicate in bath at 40° C. with high power pulses (2 sec on, 2 sec off) to disperse the particles for 10 minutes; b) Add 200 ul of SSA, continue with high pulsed sonication for several minutes. c) Continue sonication with the sample capped under nitrogen in bath at 40° C. for 2.5 hours. d) Collect and wash the sample for FTIR analysis. The C—H stretch at 2800-3000 cm-1, anhydride at 1850-1870 cm-1 and Si—O stretch at 1080 cm-1 should confirm that the surface was modified. If not steps b and c can be repeated. The rest of the procedures are the same as in Method of Preparation 1.

### Example 3

Preparation of colloidal solution of surface modified fluorescent magnetic nanoparticle coated with carboxylic acid silane as a precursor. To synthesize carboxylic acid precursor coating a following reagents needed: synthesized fluorescent magnetic nanoparticle coated with silane succinic anhydrate (SSA) precursor prepared according to Method of Preparation 2, ACS grade tetrahydrofurane (THF), anhydrous methanol. The synthesis procedure is as follows: a) 0.5 grams of nanoparticles coated with SSA is suspended in 200 ml of water and THF mixture in 50/50 proportion and sonicated in bath with high power pulses (2 sec on, 2 sec off) for 10 minutes; b) Sonication for 1 hour at 40° C.; c) After the sonication let settle for 2 minutes to remove any large agglomerates; d) Decant suspended nanoparticles and spin down; e) Wash 1 time with 50/50 mixture of water and THF and 2 times with methanol. f) Dry in vacuum at 60° C. overnight.

Nanoparticle Integration Platform/Apparatus. Also provided are magnetic and/or fluorescent nanoparticle tracers that can be integrated magnetically and detected optically or magnetically. Using continuous wave upconverting fluorescent magnetic nanoparticles (CW UFMNP), a fluid to be tested is directed through a device which magnetically collects CW UFMNPs using a magnetic field gradient, and measures their presence by detecting upconverting (multiple-photon, particularly two-photon) fluorescence. The first derivative of the spectral emission peak height with respect to time is a function of the concentration of particles. Such a device can integrate signals from nanoparticles that are diluted far below the nominal detection threshold and can thus increase sensitivity as the integration (accumulation of a number of particles over time) proceeds. This approach facilitates continuous and sensitive monitoring of nanoparticle tracers in the field.

CW UFMPs emit light in a distinct, higher energy band from the excitation band. Because this upconverting property is very rare in nature, such a device can detect these particles in almost any environment.

In suitable embodiments, a continuous laser illumination in the infrared is sued, and on long lifetime excited upconverting phosphors comprised of, for example, doped lanthanide rare earth oxides. The combination of CW (continuous wave) upconverting particles and magnetic integration of particles and the detection apparatus provides a higher signal-to-noise ratio than traditional nanoparticles, particularly in the presence of natural and other materials which contribute to background noise.

Magnetic nanoparticles are suitably integrated in the presence of a strong magnetic field gradient. In embodiments, nanoparticles are detected through their fluorescence. Natural hydrocarbons fluoresce in certain wavelength bands, however continuous wave (CW) upconversion (multiple-photon, particularly two-photon absorption) at moderate light intensities is rare. Combining these techniques in an integrative concentration measurement provides for low-concentration nanoparticle tracer detection device. Integration over time is a function of the time derivative of the peak fluorescent signal obtained within a particular wavelength band of interest. Concentration of the particles in the tested fluid is suitably determined by measuring the rate of increase of the peak in the particle emission band. As, over time, the magnet gathers more particles, the emission intensity increases.

Description of the particles. The magnetic nanoparticles, comprising a ferromagnetic core and one or more concentric coatings, as described herein, are used as fluorophores which can re-emit light upon excitation by light.

Magnetic nanoparticle coatings which are deposited as described herein can have different functions, such as a fluorescent marker or as an upconverting fluorescent marker. In certain embodiments, the outer coating may have hydrophilic properties and in other embodiments hydrophilic properties.

Nanoparticles with coatings made in this way can be used in even lower concentrations for tracer studies in applications such as groundwater tracing, enhanced oil recovery, secondary oil recovery, hydraulic fracturing (fracking), oil and gas exploration and field testing.

It will be readily apparent to one of ordinary skill in the relevant arts that other suitable modifications and adaptations to the methods and applications described herein can be made without departing from the scope of any of the embodiments.

It is to be understood that while certain embodiments have been illustrated and described herein, the claims are not to be limited to the specific forms or arrangement of parts described and shown. In the specification, there have been disclosed illustrative embodiments and, although specific terms are employed, they are used in a generic and descriptive sense only and not for purposes of limitation. Modifications and variations of the embodiments are possible in light of the above teachings. It is therefore to be understood that the embodiments may be practiced otherwise than as specifically described.

What is claimed is:

1. A method of preparing a magnetic nanoparticle, comprising:
providing a nanoparticle core comprising a ferromagnetic material;
heating the nanoparticle core to a temperature above a Curie temperature of the ferromagnetic material;
maintaining the temperature of the nanoparticle core above the Curie temperature of the ferromagnetic material; and while maintaining the temperature,
i. depositing a conformal separation layer on the nanoparticle core;
ii. depositing a conformal intermediate layer on the conformal separation layer; and
iii. depositing a conformal capping layer on the conformal intermediate layer to form the magnetic nanoparticle; and
lowering the temperature of the magnetic nanoparticle below the Curie temperature of the ferromagnetic material.

2. The method of claim 1, wherein the ferromagnetic material comprises nickel, cobalt, iron or oxides thereof.

3. The method of claim 1, wherein the heating the nanoparticle core comprises heating to a temperature that is about 5 degrees to about 500 degrees above the Curie temperature of the ferromagnetic material.

4. The method of claim 1, wherein the maintaining the temperature comprises maintaining at a temperature that is about 5 degrees to about 500 degrees above the Curie temperature of the ferromagnetic material.

5. The method of claim 1, wherein the depositing the conformal separation layer comprises depositing a silica layer or silicon dioxide layer.

6. The method of claim 1, wherein the depositing the conformal intermediate layer comprises depositing a fluorescent layer.

7. The method of claim 6, wherein the depositing the fluorescent layer comprises depositing a fluorescent upconverting layer.

8. The method of claim 1, wherein the depositing the conformal capping layer comprises depositing a silica layer or silicon dioxide layer.

9. The method of claim 1, further comprising depositing a conformal outer coating on the conformal capping layer.

10. The method of claim 9, wherein the depositing the conformal outer coating comprises depositing a hydrophilic coating layer.

11. The method of claim 1, wherein the lowering the temperature of the magnetic particle below the Curie temperature of the ferromagnetic material occurs at a rate of about 5 degrees per minute or less.

12. A magnetic nanoparticle prepared by the method of claim 1.

13. A magnetic fluorescent nanoparticle comprising: a core comprising a ferromagnetic material; a conformal separation layer on the ferromagnetic core; a conformal fluorescent layer on the conformal separation layer; and a conformal capping layer on the conformal fluorescent layer.

14. The magnetic fluorescent nanoparticle of claim 13, wherein the ferromagnetic material comprises nickel, cobalt, iron or oxides thereof.

15. The magnetic fluorescent nanoparticle of claim 13, wherein the conformal separation layer comprises silica or silicon dioxide.

16. The magnetic fluorescent nanoparticle of claim 13, wherein the conformal fluorescent layer comprises an upconverting fluorescent material.

17. The magnetic fluorescent nanoparticle of claim 13, wherein the conformal capping layer comprises silica or silicon dioxide.

18. The magnetic fluorescent nanoparticle of claim 13, further a conformal outer coating on the capping layer.

19. The magnetic fluorescent nanoparticle of claim 18, wherein the conformal outer coating comprises hydrophobic coating material.

20. The magnetic fluorescent nanoparticle of claim 18, wherein the conformal outer coating comprises hydrophilic coating material selected from the group of alcohols, carboxylic acid, amine, amide, ester, ether oxide, sulphonate, phosphonate, carboxylates, fluoro benzoic acids, poly-vinylalcohol, methylated carbon, sugars, polyols, polyethylene glycol, gluconamide, succinic acid, and combinations thereof.

21. A method of tracing a magnetic fluorescent nanoparticle in a fluid, comprising:
a. providing the magnetic fluorescent nanoparticle comprising:
i. a core comprising a ferromagnetic material;
ii. a conformal separation layer on the ferromagnetic core;
iii. a conformal fluorescent layer on the conformal separation layer; and
iv. a conformal capping layer on the conformal fluorescent layer;
b. introducing the magnetic fluorescent nanoparticle into the fluid; and
c. measuring one or more characteristics of the magnetic fluorescent nanoparticle in the fluid.

22. A colloidal solution comprising nanoparticles prepared by the method of claim 1.

23. A colloidal solution prepared from the magnetic fluorescent nanoparticle of claim 13.

24. The magnetic fluorescent nanoparticle of claim 13, wherein the ferromagnetic material is cobalt, the conformal separation layer on the ferromagnetic core comprises any of silica, silicon oxide, and mixtures thereof; the conformal fluorescent layer on the conformal separation layer is a quantum dot layer; and the conformal capping layer on the conformal fluorescent layer comprises any of silica, silicon oxide, and mixtures thereof.

25. A method to recover hydrocarbons from a subterranean formation while monitoring productivity of recovery of hydrocarbons from the subterranean formation, the method comprises:
providing a wellbore penetrating a hydrocarbon producing zone of a subterranean formation;
providing an injection stream comprising a pre-determined amount of a tracer composition which is any of hydrocarbon soluble, water soluble, and both hydrocarbon soluble and water soluble; and
allowing the tracer composition to be solubilized into fluids produced from the well;
wherein the tracer composition comprises a plurality of fluorescent magnetic nanoparticles comprising: a core comprising a ferromagnetic material; a conformal separation layer on the ferromagnetic core; a conformal fluorescent layer on the conformal separation layer; and a conformal capping layer on the conformal fluorescent layer.

26. The method of claim 25, wherein the plurality of fluorescent magnetic nanoparticles are immobilized in tracer carrier.
